(19) United States
(12) Patent Application Publication
(10) Pub. No.: US 2020/0205434 A1
(43) Pub. Date: Jul. 2, 2020

(54) Method for Forming Freeze-Dried Cheese Products

(71) Applicants: Jessilee Loucks, Twin Falls, ID (US); Daniel B. Clayton, Sheboygan, WI (US); David B. Perry, Twin Falls, ID (US)

(72) Inventors: Jessilee Loucks, Twin Falls, ID (US); Daniel B. Clayton, Sheboygan, WI (US); David B. Perry, Twin Falls, ID (US)

(21) Appl. No.: 16/730,967

(22) Filed: Dec. 30, 2019

Related U.S. Application Data
(60) Provisional application No. 62/786,544, filed on Dec. 30, 2018.

(51) Int. Cl. A23C 19/08; A23L 3/44; A23C 19/068; A23C 19/09

(52) U.S. Cl. CPC A23C 19/08; A23L 3/44; A23C 2250/10; A23C 19/0904; A23V 2002/00; A23C 19/0684

(57) ABSTRACT

Disclosed is a method for making freeze-dried shelf-stable natural cheese products having a softer, smoother texture than that of conventional freeze-dried cheese. Products made by the method include shelf-stable cheese snacks.

### FIELD OF THE INVENTION

The invention relates to methods for forming shelf-stable cheese products. More specifically, the invention relates to cheese products, such as cheese snacks, made by methods such as freeze-drying.

### BACKGROUND OF THE INVENTION

Cheese is a source of protein, fat, vitamins, and minerals. Just one ounce of many types of cheese can provide about 20 percent of the daily recommended value of calcium. While consumption of milk has generally decreased in the past few years, consumption of cheese has significantly increased and is expected to continue to increase by at least fifteen percent by 2024.

There are over 1,000 different varieties of cheese (over 1,800, by at least one count). Since cheese ingredients and production methods can be varied to produce a wide variety of different types of cheeses, many having significantly different flavors and properties, cheese is a desirable and widely-consumed snack, as well as a widely-used ingredient in many foods, including snack foods. Many snack cheeses are available, including soft cheeses packaged in foil, individually-wrapped cheese slices, and cheese sticks (a popular variety being string cheese). However, “snacks” are often on-the-go foods, making it desirable for them to be foods that do not require refrigeration. For cheese, refrigeration helps to inhibit the potential microbial, enzymatic, and/or chemical degradation that can occur over time. Various methods have been developed in an effort to try to extend the shelf-life of cheese, including adding chemical inhibitors such as, for example, mold inhibitors, using modified atmosphere packaging, high-pressure processing, and coatings, including edible coatings.

For many years, cheese snacks primarily consisted of cheese-flavored products such as, for example, cheese puffs, cheese curls, cheese crackers, and cheese straws, which usually combine the flavor of cheeses such as Cheddar, Swiss, or Mozzarella, for example, with wheat or corn meal and/or flour. Once combined, the products made with these ingredients can be extruded, rolled, shaped, and either baked or fried to give a shelf-stable cheese-flavored product that can be packaged to facilitate snacking. Cheese powder, used as a coating, can also provide added cheese flavor for many snack products. Some cheese snacks can even conveniently be made at home. Baked cheese straws, for example, are often made from a combination of cheese, butter, and flour, extruded through a cookie press or rolled and cut before baking to produce a crunchy cheese snack.

The demand for gluten-free products has led some manufacturers to develop cheese crisps made of gluten-free grains, such as quinoa, oat bran, and brown rice combined with cheese, formed, and baked.

According to The Nielsen Company (US), LLC, from 2013-2016, all individual snacking categories saw sales increases, and dairy snacks accounted for almost one-quarter of the individual snacking dollars. These days, however, much of the growth in sales of snack products is in foods that are more natural, have fewer ingredients, and can claim specific health benefits. Cheese is highly nutritious, so manufacturers have more recently focused on the development of more shelf-stable snacks that contain cheese and optional flavor inclusions, but have little else on the list of ingredients.

One form of processing that is used to make cheese more shelf-stable is drying. For example, while the moisture content of aged Parmesan is about 30 to 32 percent (and water activity (Aw) is about 0.90), to produce a more shelf-stable form of Parmesan, cheese processors usually target a moisture content of 17 to 18 percent (and Aw of 0.75). The goal is to remove moisture while minimizing the loss of aroma and flavor compounds. Drying can be accomplished by methods such as baking, freeze-drying, or microwave vacuum-drying (such as that described in U.S. Pat. No. 9,958,203). Dried, crispy snacks advertised as “only 100% cheese” are currently sold under trade names such as Groksi!®, Whisps®, and Moon Cheese®, with Groksi!® and Whisps® being representative of baked cheese snack products, and Moon Cheese® being representative of cheese snacks made of cheese dried by radiant energy vacuum.

A variety of terms can be used to describe the flavors of cheese, and a variety of terms can also be used to describe the texture of cheese. Terms used to describe the texture of cheese include, for example, spreadable, chewy, soft, elastic, crumbly, creamy, moist, velvety, and even dry. One list of terms used to describe the texture of cheese can be found, for example, at http://www.cheeselibrary.com/describing_cheese.html. Two terms that are generally not found on the list, however, are “crispy” and “crunchy.” While many consumers love the crunch of cheese snacks, they are not representative of the natural texture of cheese. It would therefore meet a need in the market to provide shelf-stable cheese snacks that have a texture that is closer to the natural texture of cheese although the requisite amount of moisture has been removed to promote shelf-stability.

### SUMMARY OF THE INVENTION

The invention relates to a method for making cheese snacks, the method comprising forming a substantially homogeneous cheese slurry by comminuting at least one cheese, admixing the comminuted cheese with water, forming a colloidal dispersion of the admixed cheese and water, and applying to the cheese/water admixture sufficient shear to form a substantially homogeneous slurry; aliquoting the slurry; and freeze-drying the aliquoted slurry to form at least one freeze-dried cheese snack. The cheese/water admixture can be, in various embodiments, heated in order to promote formation of the slurry. In various aspects of the invention, the step of forming the colloidal dispersion is performed without the addition of sufficient heat to reach the melting temperature of the at least one cheese.

In various embodiments of the method, the step of comminuting the at least one natural cheese can be performed by a method or methods selected from the group consisting of mechanically breaking the cheese into smaller chunks, grinding the cheese, shredding the cheese, and combinations thereof. In various embodiments, the step of admixing the comminuted cheese with water and homogenizing the resulting cheese/water admixture to form a cheese slurry can be performed by loading the water and cheese into a device selected from the group consisting of shear mixers, colloid mills, pressure valve homogenizers, ultrasonic homogenizers, and combinations thereof. In aspects of the invention, the cheese slurry will generally contain from about 10 to about 50 percent (w/v) cheese solids. In some aspects of the invention, the cheese/water admixture comprises at least about 30% solids.

In various embodiments of the method, the step of heating the cheese slurry is performed by heating the cheese slurry to a temperature of from about 50° F. to about the melting point of the cheese or, when a mixture of cheeses is used, the melting point of the cheese that has the lowest melting point.

The invention also provides a method for preparing a freeze-dried cheese product, the method comprising the steps of adding at least one comminuted cheese to water to form a cheese/water admixture, forming a colloidal dispersion from the cheese/water admixture by the addition of shear and heat, the temperature of the cheese/water admixture during this step being less than the melting point temperature of the cheese, forming a homogeneous slurry from the colloidal dispersion by the application of additional shear, and the optional addition of heat, sufficient to homogenize the dispersion to form the homogeneous slurry, and freeze-drying the homogeneous slurry. In various aspects of the method, the addition of heat raises the temperature of the colloidal dispersion to above the melting point temperature of the cheese.

Aspects of the method also comprise solidifying at least one homogenous cheese slurry and thereby forming at least one solid piece from the slurry, wherein the step of solidifying the slurry is performed by freeze-drying the slurry. In various embodiments of the method the slurry is dispensed into molds of desired size and shape before the slurry is freeze-dried.

### BRIEF DESCRIPTION OF THE DRAWINGS

FIGS. 1a, 1b, and 1c are photographs of samples of shelf-stable natural cheese snack products made by the method of the invention. Cheese snack products in FIG. 1b were produced by the addition of flavoring particles, resulting in a variegated appearance, as shown.

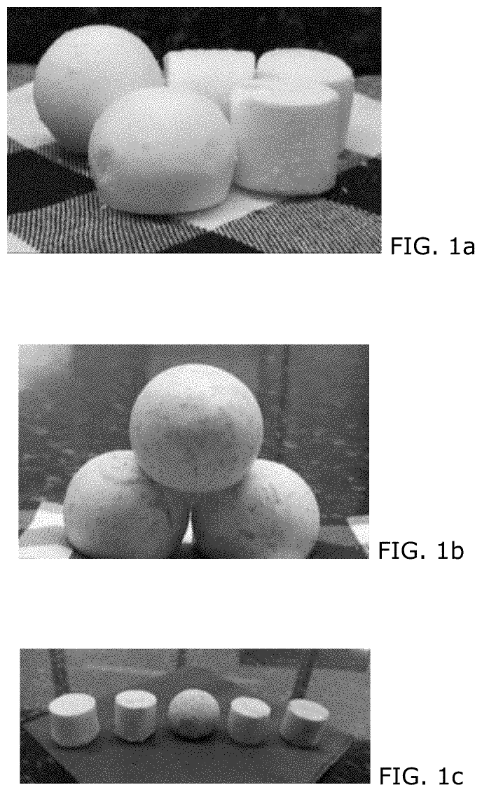

FIG. 2a is a photograph of a cheese/water colloidal dispersion, and FIG. 2b is a photograph of a homogenized cheese slurry resulting from the addition of added heat and shear to the cheese/water colloidal dispersion.

### DETAILED DESCRIPTION

The inventors have discovered a method for making cheese products that are shelf-stable, yet provide texture that is closer to the smooth, creamy texture of cheese than are the crispy, crunchy snack products made by baking natural cheese such as shredded Parmesan or Cheddar. These products also provide a way to produce shelf-stable cheese in a form that has a melt-in-your-mouth consistency, rather than the plastic-like, tough pieces of freeze-dried cheese that are familiar to those in the industry. These inventive cheese products include, for example, snacks comprising dried cheese, but they have a texture that is more like that of a butter mint, having a relatively smooth, creamy mouthfeel, instead of a crispy crunch. The cheese snack products fit well into the popular ketogenic diet, with about 75% of the snack's calories being derived from fat, 23% being derived from protein, and only 2% being derived from carbohydrates, for example. Generally containing only cheese as an ingredient, with enzymes (e.g., cross-linking enzymes, phospholipases) flavorings, and/or other basic types of inclusions optionally added, the snacks can readily be made as clean-label products.

The inventors have discovered that a combination of shear and heat can be used to produce products of the invention, having a texture that is significantly different—and more like that of natural cheese—than products made using conventional freeze-drying methods. A “slurry,” as used herein, is defined as a semiliquid mixture of fine particles suspended in water. Cheese slurries have been used in methods for making both freeze-dried and spray-dried cheese products, but those products have traditionally been powdered cheese products. For example, production of cheese powder by spray-drying has been described as combining the steps of blending natural cheese, water, emulsifying salts, and optional additives such as flavors, flavor enhancers, and coloring agents, then heating the blend to 75 to 85° C. and shearing to produce a hot molten slurry, which is subsequently spray-dried (Koca, N. et al., Effects of spray-drying conditions on the chemical, physical, and sensory properties of cheese powder, Journal of Dairy Science (2015) 98(5): 2934-2943). In one reported effort to freeze-dry a cheese slurry, in order to grind the freeze-dried intermediate product to produce a cheese powder end-product, the product resulting from freeze-drying the slurry (i.e., the intermediate product) was described as a dry, brittle cake. (Emteborg, H. et al., Infrared Thermography for Monitoring of Freeze-Drying Processes: Instrumental Developments and Preliminary Results, Journal of Pharmaceutical Sciences (2014) 103: 2088-2097.) Dry, brittle cakes are suitable for grinding to form a powder, but are clearly not very appetizing as cheese snack products. The present method provides a way to prepare cheese for freeze-drying to give resulting products that are not brittle—an advance that can also be used to produce products that can be more easily ground to provide shelf-stable cheese powders.

The inventors have discovered that processing cheese using high shear and homogenization (e.g., using a high-pressure valve homogenizer, colloid mixer, etc.) in a gradient manner produces a cheese slurry that can be freeze-dried to produce a non-brittle product that is shelf-stable, yet closer to the expected texture of natural cheese than are conventional products made using baking, spray-drying, and other water-removal processes. The method uses the combination of shear/homogenization and heat, the temperature during the process generally being from about 50° F. to about 150° F. The timing and intensity of the application of heat is important in various aspects of the invention, for reasons that are explained below.

The invention relates to a method for making cheese snacks, the method comprising forming a cheese slurry by a method wherein at least one cheese is comminuted, the comminuted cheese is admixed with water, a colloidal dispersion is formed of the admixed cheese and water with heat and shear, and a slurry is formed by the addition of heat and shear to the cheese/water admixture sufficient to form a substantially homogeneous slurry; aliquoting the slurry; and freeze-drying the aliquoted slurry to form discrete pieces of freeze-dried cheese snacks. In various aspects of the invention, the step of forming the colloidal dispersion is performed without the addition of sufficient heat to reach the melting temperature of the at least one cheese.

In various embodiments of the method, the step of comminuting the at least one natural cheese can be performed by a method or methods selected from the group consisting of mechanically breaking the cheese into smaller chunks, grinding the cheese, milling the cheese, shredding the cheese, and combinations thereof. Shredding to produce fancy shreds is a convenient and effective method that can readily be used. In various embodiments, the step of admixing the comminuted cheese with water and homogenizing the resulting cheese/water admixture to form a cheese slurry can be performed by loading the water and cheese into a device selected from the group consisting of shear mixers, colloid mills, pressure valve homogenizers, ultrasonic homogenizers, and combinations thereof. In aspects of the invention, the cheese slurry will generally contain from about 10 to about 50 percent (w/v) cheese solids, and it should be noted that solids levels can also be increased by the addition of cheese powder, or by concentrating the cheese/water admixture (e.g., by filtration and/or evaporation) to give a higher solids content. In some aspects of the invention, the cheese slurry will generally contain from about 25 to about 45 percent (w/v) cheese solids. In some aspects of the invention, the cheese slurry will generally contain from about 30 to about 40 percent (w/v) cheese solids.

In various embodiments of the method, the step of forming the colloidal dispersion is performed by bringing the cheese/water admixture to a temperature of from about 50° F. to about the melting temperature of the cheese used to produce the slurry, or the melting temperature of the cheese having the lowest melting point, if a mixture of cheeses is used. This may be done by heating the cheese and water, by adding the comminuted cheese to warm or hot water, or any suitable method known to those of skill in the art.

Cheese curds, “young” cheese, and/or aged cheese(s), as well as cheese powder (which may optionally be added to form the slurry) can be used as starting material in the method of the invention. Cheeses of a variety of types can be used, as well as mixes of cheeses, with cheeses having a melting temperature of from about 130° F. to about 180° F. (Cheddar, Mozzarella, Gouda, Havarti, Colby, Colby Jack, Gruyere, Monterrey Jack, Blue Cheese, Swiss, Raclette, Manchego, Parmesan, Asiago, Edam, and combinations thereof, for example, including curds and/or powders thereof) being ideally suited for use in the method, while restricted-melt cheeses may generally be less so.

The method for creating the slurry to be freeze-dried combines both mixing (shearing, homogenizing, etc.) and heating, with the exact heat and shear conditions being adjusted according to the cheese(s) selected, the goal being to mechanically disrupting the comminuted cheese sufficiently by the mixing/shearing process to prevent pasta filata-style stretching of the cheese when the temperature is increased to approach the melting point of the cheese(s). Applying a sufficient amount of heat too soon before the cheese can be broken apart during the shearing process can also result in leaching of fat from the cheese, which is not desirable. Without being bound by theory, the inventors believe that the protein in the cheese acts as an emulsifier to promote the production of a smoother slurry and superior dried cheese product. The method of the invention is thought to enhance hydration of the proteins, which further enhances the emulsification effect.

Aspects of the method also comprise solidifying at least one homogenous cheese slurry and thereby forming at least one solid piece from the slurry, wherein the step of solidifying the slurry is performed by freeze-drying the slurry. In various embodiments of the method the slurry is dispensed into molds of desired size and shape before the slurry is freeze-dried. By dispensing the slurry into molds, it is possible to produce freeze-dried cheese snacks of desirable shapes. For example, bite-size cheese snacks can be made to look like miniature cheese wedges, cheese snacks can be formed in cubes, rectangles, spheres, etc. Holiday-themed shapes could be produced during holiday seasons (e.g., bell-shaped, tree-shaped, etc.).

When Cheddar cheese, for example, is freeze-dried by conventional methods, the resulting product has the shape of the original piece of cheese before the drying process, but the texture is tougher, and has more of a plastic-like appearance and consistency. This tougher, more plastic-like nature of the dried cheese plays a significant role in an undesirable property known as “toothpack”—i.e., when food that has been chewed packs into the crevices of the teeth. The method of the invention is designed to achieve an effect on the structure of the cheese that produces smoother, softer-textured products resulting from freeze-drying cheese. The product produced by the method also significantly reduces or eliminates toothpack. The method also allows the manufacturer to create cheese snacks having specific shapes, varieties of shapes, etc., that are not dependent upon the shape of the original cheese starting material.

Cheese has plasticity because of its unique molecular structure. About 80% of the protein found in milk is casein protein. In milk, the casein molecules form compact spheres that are packed together with calcium and phosphate ions to form microscopic micelles. Chemical and/or enzymatic treatment during cheese-making causes the casein molecules to partially destabilize and link with each other, the interconnected micelles forming a mesh-like structure that forms a semisolid gel.

The unique molecular structure of cheese provides opportunities for modifications produced, at least in part, by the use of chemical and/or physical means to produce desirable changes in the cheese structure. What is often referred to as “melting” of cheese is actually a glass transition. When the “melting” point of a particular cheese is reached, the cheese actually remains solid, but becomes a “rubbery” solid, which flows easily. Manipulation of cheese curd—by stretching the cheese, applying heat, applying pressure, etc., can be used to modify the cheese gel and increase its plasticity. For example, cheese curd becomes softer and smoother under warm water, and if sufficient heat is applied, the curd will stretch. This process—stretching the curd—is how pasta filata-type cheeses are made. In Mozzarella cheese, for example, the aligned calcium phosphate paracasein fibers give melted Mozzarella its stringiness. In the manufacture of a pasta filata-type cheese such as Mozzarella, the fermented curd is subjected to a plasticization step during which it is heated to at least about 130° F., kneaded, and stretched in hot water (175° F.). Queso fresco, on the other hand, is made by methods that disrupt and weaken the protein matrix so that the cheese crumbles, but generally does not melt.

The inventors have discovered that the application of heat in combination with shear, while avoiding the creation of conditions that would result in stretching of the cheese curds (and/or comminuted pieces thereof) during the production of a cheese slurry, can result in the production of freeze-dried cheese products made from the slurry that are not tougher, or more plastic in nature, than the cheese starting material, but rather are smoother, softer, creamier dried-cheese products that are easy to bite into and have excellent flavor and mouthfeel. This is accomplished by mechanically breaking the cheese into finer pieces, using the combination of heat and shear, to produce a colloidal dispersion of cheese in water at a temperature that is below the melting temperature of the cheese used to produce the colloidal dispersion. The colloidal dispersion can then be further processed, which can include the addition of heat sufficient to reach the melting temperature of the cheese, the combination of shear and optional additional heat being used to process the colloidal dispersion to produce a homogeneous cheese slurry. A homogeneous cheese slurry, or substantially homogeneous slurry, as used herein, is a slurry containing cheese particles that are of similar size and generally uniformly-distributed. The slurry can then be dispensed into suitable molds of desired size and shape, and the slurry is frozen (i.e. pre-frozen), then subjected to freeze-drying to sublimate the water in the slurry and dry the cheese, producing formed cheese pieces having the shape of the mold(s) into which the slurry was introduced. Freezing can take place with the shaped, pre-frozen shapes removed from the molds, or left in the molds during the freeze-drying process. Molds can be made of non-reactive materials such as silicone, cornstarch, etc.

Cheese products of the present invention are produced by applying sufficient shear to break apart the cheese into finer particles to form a cheese slurry before a sufficient amount of heat is applied that would, under other circumstances, promote the molecular interactions that produce pasta filata-type, more plastic, changes in the cheese. The combination of heat and shear aids in breaking apart the cheese to produce the slurry, but what the inventors have learned is that it is beneficial in the method of the invention to control the addition of heat to avoid the reorientation/alignment of the casein molecules early in the process, and instead mechanically break down the cheese structure before the addition of sufficient heat to cause the curd to stretch. Also, it can be important to avoid homogenizing at temperatures that will result in irreversible change in the cheese structure. Generally, this would mean keeping the temperature during the initial homogenization to produce the colloidal dispersion below the melting point of the cheese, or below the melting point of the lower-melting-point cheese, if a blend of cheeses is used. As it goes through glass transition (i.e., “melts”), cheese becomes more viscous in nature. At about 90° Fahrenheit, the milk fat in cheese begins to liquefy, and beads of melted fat rise to the surface. As the fat within the cheese is melted, the liquid fat can then move through holes in the protein matrix to be released at the surface, creating structural changes within the cheese. If the temperature is too high or the cheese is heated for too long, the protein molecules tighten and force out both water and fat—resulting in a rubbery, greasy, “melted” cheese. Once it reaches this stage, the changes are generally irreversible. Generally, this is to be avoided in order to optimize the quality and texture of the cheese snack products resulting from the method of the invention, and the present method does avoid the oiling-off of fat in the cheese, resulting in cheese snacks that retain the oils, but are not “greasy” to touch or taste.

Producing the colloidal dispersion is preferably done by the combination of shear and heat, with a homogenization temperature that is generally below about 130 degrees Fahrenheit (110 degrees Fahrenheit, for example). The temperature at this stage, whether the result of the addition of heated cheese, heated water, by the heating of the mix, or by any action that would result in an increase in the temperature of the cheese/water admixture, should be maintained at less than the melting point temperature of the cheese or cheeses used to produce the colloidal dispersion, although there may be circumstances that, to one of skill in the art, warrant the addition of heat sufficient to increase the temperature above the melting point temperature. For example, a higher level of heat might be used to produce a colloidal dispersion of an older (i.e., more aged) cheese. For Cheddar cheese, for example, the inventors suggest that mixing be initiated with cheese that is from about 35 degrees Fahrenheit to about 90 degrees Fahrenheit and water temperature for mixing that is from about 50 degrees Fahrenheit to about 130 degrees Fahrenheit, with the ideal temperature being equipment-dependent to achieve maximum results.

“Shear” refers to the application of stress in more than one direction. This can be achieved by the application of a physical force such as cutting, by the application of pressure, or by other means known to those of skill in the art. When a sufficient amount of shear is added to the comminuted cheese, the pieces of cheese are broken into numerous smaller pieces. These numerous smaller pieces create the colloidal dispersion, and the application of shear sufficient to create the dispersion can readily be performed using a device such as a shear mixer or a colloid mill. A variety of homogenizers can, however, produce the desired results. A colloid mill mixing blade speed of from about 30 to about 60 hz with additional side agitation has been used by the inventors with excellent results. For the pressure homogenizer, it is advisable that the cheese temperature be about 140° F. When a colloid mill is used, the temperature should be in the range of from about 50° F. to about 150° F. Where commercial-scale processing is used, it is recommended that the temperature be at least about 110° F.

The degree of homogenization desirable for the method of the invention can readily be achieved using commercial equipment such as colloid mills and pressure homogenizers, for example. According to one manufacturer, BEE International (www.beei.com), a colloid mill is a type of rotor-stator mixer which can be used to reduce the particle size of solids in suspension. Inside the colloid mill, a high-speed rotor pushes the fluid through small holes in a stationary stator, creating extremely high levels of mechanical shear. The sizes of these holes or gaps is adjustable, so the level of shear can be controlled. The higher the shear, the smaller the resulting particle size. High-pressure homogenizers are often used in the dairy industry, where they are capable of creating emulsions and reliably processing large volumes of ingredients. A colloid mill with rotor high blade-spin frequency (e.g., about 30-45 Hz) can be used to create the colloidal dispersion.

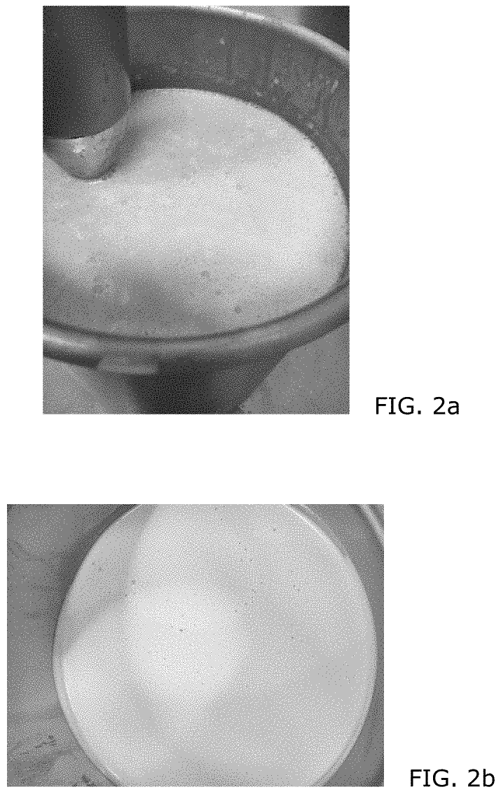

Once a colloidal dispersion has been formed of the cheese/water admixture, it is then desirable, using the same equipment or different equipment, to further process the dispersion by additional shear and optional additional heat to produce a homogeneous slurry which can then be freeze-dried to produce cheese snacks of the invention. FIGS. 2a and 2b illustrate a cheese/water colloidal dispersion and a homogeneous cheese slurry, respectively.

It should be noted that if the cheese/water mixture is held before beginning the homogenization step, it should preferably be agitated during this holding step. Once homogenized, the slurry can be freeze-dried to produce dried cheese snack products of the present invention.

Without being bound by theory, the inventors believe that physically disrupting the cheese before it reaches its melting point/glass transition temperature keeps the cheese from reaching its rubber transition stage. This is the irreversible change that is characteristic of the crunchy natural cheese products currently on the market, such as the baked natural cheese crisps. Enzymatic breakdown of cheese, like that which occurs naturally during aging, for example, has been shown to produce a cheese that can be heated at its melting point without creating a pasta filata-like state, which supports their hypothesis. It also appears that the method of the invention produces a product that is less greasy and has less free oil because the fat has been homogenized in with the protein prior to the application of an appropriate amount of heat, while traditional methods for creating cheese snacks have involved the application of heat in a manner that produces the expulsion of fat to the cheese surface. When the fat within the cheese is melted, the liquid can then move through holes in the protein matrix to be released at the surface, creating structural changes within the cheese. The present method significantly decreases, or eliminates, these issues.

Forming cheese snack pieces is accomplished, for example, by aliquoting the homogenized cheese slurry into chambers having the desired volume and shapes for the final snack pieces, followed by pre-freezing and then freeze-drying. Pre-frozen pieces can be removed from the forming chambers before the next steps in the freeze-drying process are initiated, or the pre-frozen pieces can be left in the forming chambers during the rest of the freeze-drying process, and then removed. Another option for forming the cheese snack pieces is extruding the slurry onto a solid surface to produce a ribbon of slurry, pre-freezing, freeze-drying, and then cutting the ribbon into smaller pieces. (Cutting may optionally be done prior to the pre-freeze step, which may comprise an individual quick freeze, or other freezing process known to those of skill in the art). Those of skill in the art will understand that a variety of methods for forming the cheese snack pieces may be used, given the information provided herein.

In various embodiments of the method, the drying step can comprise two phases, a first drying phase being performed under vacuum at a temperature that is slowly increased from the triple-point temperature of the slurry (e.g., about −20 degrees Celsius) to about 20 degrees Celsius over a period of several hours. This drying phase may also be referred to as the “ramp” phase. During this ramp phase, ice crystals that have formed on the slurry as the result of freezing the slurry to at or below the triple point temperature will undergo sublimation to remove the “unbound” water from the slurry. The drying step can also comprise a second phase, which may be referred to as the “soak” phase, producing desorption of bound water from the slurry. In various embodiments of the method, both the ramp and soak phases (i.e., the first drying phase and the second drying phase) are performed under vacuum and the vacuum pressure is 100-300 millitorr. In various embodiments, the first drying phase is performed under vacuum at a temperature that is slowly increased from the triple-point temperature (e.g., about −20 degrees Celsius) to about 20 degrees Celsius and the second drying phase held at about the ending temperature of the first phase. Both phases are allowed to proceed for a period of time that achieves the desired target moisture, which is about equal to or less than 10%. Furthermore, those of skill in the art will recognize that the ramp-and-soak processes may be repeated, so one could choose to perform one cycle or multiple ramp/soak cycles. Generally, although drying is described as two phases that can be performed separately, they may generally overlap to at least some extent.

The frozen slurry is then placed in a vacuum drying chamber. After the vacuum of the dryer is released, the dried shelf-stable snack product is removed from the freeze-dryer.

The invention also relates to products made by the method of the invention, these products being useful for shelf-stable cheeses and cheese products such as cheese snacks comprising different types of cheeses, cheese curds, cheese powders, a variety of different types of flavorings, and various sizes of the snacks, as well as animal feed and/or treats, coatings for layered freeze-dried products, center layers for layered freeze-dried products, salad toppings, additions to soup mixes, toppings for soups, garnishes for savory food dishes, and shelf-stable probiotic delivery systems, just to name a few examples.

Flavorings, such as spices, flavor granules, etc., may be added to the cheese slurry to produce flavored cheese snacks. Other ingredients, such as proteins and proteinaceous foods (e.g., eggs), which are acceptable for freeze-drying in combination with cheese, may be added to produce combination snacks having the nutritional and taste benefits of cheese. Additional nutrients can be added, as well. Various cheese powders can be used, either alone, or in combination with comminuted cheese and/or cheese curd. If cheese powder is used, it can be added at one or more points during the method of forming the colloidal dispersion, heating, forming the homogeneous slurry, or even after the formation of the slurry. Air or other gas (e.g., CO₂) can also be incorporated into a slurry formed by the method of the invention, such addition being done by various means known to those of skill in the art.

Where the term “comprising” is used herein, it should be understood that “consisting essentially of,” or “consisting of” may also be used. The invention may be further described by means of the following non-limiting examples.

### Examples

### Cheddar Cheese Snacks—Batch 1

Cheddar cheese was comminuted by shredding to a fancy shred format. (Fancy shred produces a thin ribbon of cheese, while feather shred produces a thicker and flatter ribbon of cheese.) Water at 70° F. was added to a colloid mill with high blade-spin frequency (30-45 Hz), followed by the addition of comminuted cheese to give a cheese/water admixture with 35% solids to produce a colloidal dispersion. The mixer tank was then heated from 70° F. to 175° F. over a 12-minute time period. The cheese slurry was transferred to a 2-stage pressure homogenizer while still hot, with the first stage set to 2000 psi and second stage set to 500 psi. Following homogenization, the homogenate was collected and cooled to 40° F. from about 120° F. The homogenate (slurry) was poured into molds, and the molds placed in a blast freezer set at −40° C. When frozen, the pieces were taken out of the molds and placed in pans. The pans were placed in the freeze dryer, which was then set to run a typical 2-stage ramp-and-soak process to produce a product having less than 4% moisture, which was then removed from the dryer.

### Cheddar Cheese Snacks—Batch 2

Cheddar cheese was comminuted using fancy shred format. Water at 70° F. was added to a to a colloid mill with high blade-spin frequency (30-45 Hz), followed by the addition of comminuted cheese to give a cheese/water admixture with 35% solids for the initial stage of homogenization. The mixer tank was then heated from 70° F. to 175° F. over a 12-minute time period. The admixture was transferred to a 2-stage pressure homogenizer while still hot, with the first stage set to 2000 psi and the second stage set to 500 psi. The homogenate (slurry) was collected and cooled until it was from about 120° F. to about 40° F. Natural Cheese Powder (100%) was added to the homogenate and mixed to increase homogenate solids to 45% and add flavor. The resulting slurry was poured into molds and the molds were placed in a blast freezer set at −40° C. When frozen, the pieces were taken out of the molds and placed in pans, which were placed in the freeze dryer. The freeze dryer was set to run a typical 2-stage ramp-and-soak process to produce a cheese product having less than 4% moisture, which was then removed from the dryer.

### Cheddar Cheese Snacks—Batch 3

Cheddar cheese was comminuted to fancy shreds. Water at 70° F. was added to a to a colloid mill with high blade-spin frequency (30-45 Hz), followed by the addition of comminuted cheese to give a cheese/water admixture with 35% solids for the initial stage of homogenization. The mixer tank was then heated from 70° F. to 175° F. over a 12-minute time period. The admixture (cheese slurry) was transferred to a 2-stage pressure homogenizer while still hot, with the first stage set to 2000 psi and the second stage set to 500 psi. The resulting homogenate was collected and cooled until it was from 500° F. to about 40° F. Natural Cheese Powder (100%) was added to the homogenate and mixed to increase homogenate solids to 55%. Thick, cooled homogenate was processed using extrusion to create shape using either die or the shape of the extruder outlet. The extruded homogenate was cut in to final shape as it came out of the extruder. Product was then individual quick froze with liquid nitrogen and placed on a tray which was then quickly placed in a freeze dryer set to run a typical 2-stage ramp- and soak-process to produce a product with less than 4% moisture, which was then removed from the dryer.

### Particle Size of Cheese in Slurries

Two slurries made from fresh curd and the year-old aged Cheddar were collected after shear-mixing, and again after pressure-homogenizing. Slurries comprised 35% solids and were cooked with constant mixing and agitation, with water temperature starting at 70° F. and a heat ramp going up to 175° F. in about 15 minutes. Batches weighed 50 pounds each. Particle size results are shown below in Table 1.

TABLE 1
Effect of Cheese Age on Particle Size (MV*) in Slurries
Processed Using Shear-Mixing and Pressure-Homogenization

| | Slurry Produced From | | | |
|---|---|---|---|---|
| | Curd | | Aged Cheddar | |
| Sample | Shear- | Pressure- | | Pressure |
| Number | Mixing | Homogenization | Almix | Homogenization |
| 1 | 129.5 | 45.56 | 28.18 | 17.84 |
| 2 | 116 | 76.03 | 21.85 | 23.28 |
| 3 | 76.32 | 80.16 | 22.53 | 23.45 |
| Average | 107.2733_{A} | 67.25_{AB} | 24.18667_{BC} | 21.52333_{C} |

The data demonstrates that for a specific cheese there is not a significant difference between processing using shear-mixing and pressure-homogenization, but between cheeses of different ages there is a distinct difference. This data also gives a good range of what particle sizes can be expected for cheese slurries created with fresh curd having the larger particles and the aged curd having smaller particles due to enzymatic breakdown. The inventors have conducted similar tests with other cheeses of other ages to confirm that those cheese slurries fit in the particle range size as seen in Table 1.

### Oxidation and Shelf-Life

Oxidation was compared between five products—(1) a product made by the method of the invention (Glanbia® Control), (2) a product made by the method of the invention, with the addition of phospholipase (Glanbia® (PL Treatment), (3) a baked Cheddar cheese crisp sold under the product name Sonoma Creamery® Cheddar Cheese Crisps (Sonoma Creamery, California), (4) a baked Cheddar cheese crisp sold under the product name Whisps® (Schuman Cheese, Inc., NJ), and a Cheddar cheese snack made using a radiant energy vacuum technology and sold under the product name Moon Cheese® (NutraDried Food Company LLC, WA).

Measurements were performed using the OXITEST® (VELP Scientific, Inc., Bohemia, N.Y.), which speeds up product sample oxidation using temperature and oxygen pressure, measuring the absolute pressure change inside two chambers and monitoring the oxygen uptake of the active components in the samples. From that, it generates an IP (Induction Period) value (i.e., the time required to reach the starting point of oxidation, corresponding to either a level of detectable rancidity or a sudden change in the rate of oxidation). The higher the IP value, the higher the stability against oxidation over time. Table 2 shows the results obtained.

TABLE 2
OXITEST Induction Point at 90° C.

| Product | Age | Sample 1 | Sample 2 | Average |
|---|---|---|---|---|
| Glanbia ® | Made: Mar. 22, 2019 | 38:10 | 39:08 | 38:39 |
| Control | | | | |
| Glanbia ® (PL | Made: Mar. 22, 2019 | 46:00 | 48:14 | 47:07 |
| Treatment) | | | | |
| Sonoma | BB: Oct. 6, 2019 | 27:09 | 29:21 | 28:15 |
| Creamery ® | Made: Jan. 6, 2019 | | | |
| Cheddar | 9 Month Shelf Life | | | |
| Cheese Crisps | | | | |
| Whisps ® | BB: Jan 9, 2020 | 18:43 | 17:40 | 18:12 |
| Moon | BB: Oct. 25, 2019 | 23:21 | 26:05 | 24:43 |
| Cheese ® | | | | |

Oil/fat was measured for each of the five products listed in Table 3. Results are shown as percentage of surface fat vs. percentage of non-surface fat.

TABLE 3
Percent Surface Fat

| | | | | Calc. % | |
|---|---|---|---|---|---|
| | | | | Fat in | Non- |
| | | | Average | Product | Surface |
| | Sample | Sample | of #1 & | as Per | Fat |
| Product | #1 | #2 | #2 | Label | Proportion |
| Glanbia ® | 49.77 | 49.32 | 49.55 | 52.95% | 6.4% |
| Control | | | | | |
| Glanbia ®, | 50.93 | 50.18 | 50.56 | 52.95% | 4.5% |
| Phospholipase | | | | | |
| Treatment | | | | | |
| Sonoma | 29.87 | 32.77 | 31.32 | 24.6% | 0%* |
| Creamery ® | | | | | |
| Cheddar | | | | | |
| Cheese Crisps | | | | | |
| Whisps ® | 34.80 | 37.29 | 36.05 | 35.7% | 0%* |
| Moon Cheese ® | 47.71 | 47.59 | 47.65 | 41.6% | 0%* |

*Estimated as 0% because total fat is assumed based on nutrition label and not wet chemistry methods, otherwise values would be negative.

As illustrated in the tables above, products made by the method of the invention do not reach the OXITEST induction point until heat-stressed for two to four times as long as for the other products, indicating that the products of the invention have longer shelf-life than do similar products in the marketplace. The data also demonstrates phospholipase treatment (i.e., addition of phospholipase) can significantly extend the shelf-life of the snack. Based on the fat data in Table 3, it appears that products of the invention have significantly less surface fat, which may help to explain the increase in shelf-life. Furthermore, less surface fat will produce a less greasy texture to the product.

What is claimed is:

1. A method for making cheese snacks, the method comprising
a) forming a substantially homogeneous cheese slurry by comminuting at least one cheese, admixing the comminuted cheese with water, forming a colloidal dispersion of the admixed cheese and water, and applying to the cheese/water admixture sufficient shear to form a substantially homogeneous slurry;
c) aliquoting the slurry; and
d) freeze-drying the aliquoted slurry to format least one freeze-dried cheese snack.

2. The method of claim 1 wherein heat is added during the step of forming the slurry.

3. The method of claim 2 wherein the colloidal dispersion is formed without the addition of sufficient heat to reach the melting temperature of the at least one cheese.

4. The method of claim 1 wherein the step of comminuting the at least one natural cheese is performed by a method selected from the group consisting of mechanically breaking the cheese into smaller chunks, grinding the cheese, shredding the cheese, and combinations thereof.

5. The method of claim 1 wherein the cheese slurry comprises from about 10 to about 50 percent (w/v) cheese solids.

6. The method of claim 1 wherein the cheese slurry comprises from about 25 to about 45 percent (w/v) cheese solids.

7. The method of claim 1 wherein the cheese slurry comprises from about 30 to about 40 percent (w/v) cheese solids.

8. The method of claim 1 wherein the step of heating the cheese slurry is performed by heating the cheese slurry to a temperature of from about 50° F. to about the melting point temperature of the cheese.

9. The method of claim 1 wherein the step of heating the cheese slurry is performed by heating the cheese slurry to a temperature of from about 50° F. to about 130° F.

10. The method of claim 1 wherein the step of heating the cheese slurry is performed by heating the cheese slurry to a temperature of from about 110° F. to about 130° F.

11. The method of claim 1 further comprising the step of increasing the solids content by adding cheese powder to the admixture, colloidal dispersion, slurry, or a combination thereof.

12. The method of claim 1 further comprising the step of increasing the solids content by concentrating the colloidal dispersion, the slurry, or both.

13. The method of claim 1 wherein the cheese is selected from the group consisting of cheese, curds, powders, and combinations thereof chosen from the group consisting of Cheddar, Mozzarella, Gouda, Havarti, Colby, Colby Jack, Gruyere, Monterrey Jack, Blue Cheese, Swiss, Raclette, Manchego, Parmesan, Asiago, Edam, and combinations thereof.

14. The method of claim 1 wherein the steps of forming the colloidal dispersion and forming the homogeneous slurry can be performed by loading the water and cheese into a device selected from the group consisting of shear mixers, colloid mills, pressure valve homogenizers, ultrasonic homogenizers, and combinations thereof.

15. A method for producing a cheese product, the method comprising solidifying at least one homogenous cheese slurry and thereby forming at least one solid piece from the slurry, wherein the step of solidifying the slurry is performed by freeze-drying the slurry.

16. A method for producing a freeze-dried cheese product, the method comprising the steps of
a) adding at least one comminuted cheese to water to form a cheese/water admixture;
b) forming a colloidal dispersion from the cheese/water admixture by the addition of shear and heat, the temperature of the cheese/water admixture during this step being less than the melting point temperature of the cheese;
c) forming a homogeneous slurry from the colloidal dispersion by the application of additional shear, and the optional addition of heat, sufficient to homogenize the dispersion to form the homogeneous slurry; and
d) freeze-drying the homogeneous slurry to provide a freeze-dried cheese product.
